(19) United States
(12) Patent Application Publication
(10) Pub. No.: US 2017/0321110 A1
(43) Pub. Date: Nov. 9, 2017

(54) ENHANCED OIL RECOVERY FLUID COMPRISING POTASSIUM CARBONATE, ASSOCIATED METHODS AND ARRANGEMENT

(71) Applicant: MONTANUNIVERSITÄT LEOBEN, Leoben (AT)

(72) Inventor: Herbert HOFSTÄTTER, Voecklabruck (AT)

(21) Appl. No.: 15/523,303

(22) PCT Filed: Oct. 29, 2015
(86) PCT No.: PCT/EP2015/075181

§ 371 Date: Apr. 28, 2017

(30) Foreign Application Priority Data
Oct. 30, 2014 (GB) 1419366.8

(51) Int. Cl. C09K 8/58; C09K 8/54; E21B 43/20

(52) U.S. Cl. CPC C09K 8/58; E21B 43/20; C09K 8/54; C09K 2208/12; C09K 2208/20

(57) ABSTRACT

Embodiments of the invention relate to an oil recovery medium for injection into a ground hole in a ground comprising oil, a method of recovering oil from a reservoir utilizing the oil recovery medium, an arrangement for recovering oil from a reservoir, and a method of using an oil recovery medium or an arrangement for recovering oil from a reservoir. The oil recovery medium for injection into a ground hole in a ground comprising oil comprises a base liquid and potassium carbonate.

This application is the U.S. national phase of International Application No. PCT/EP2015/075181 filed 29 Oct. 2015 which designated the U.S. and claims priority to British Patent Application No. 1419366.8 filed 30 Oct. 2014, the entire contents of each of which are hereby incorporated herein by reference.

### FIELD OF THE INVENTION

Embodiments of the invention relate to an oil recovery medium for injection into a ground hole in a ground comprising oil, a method of recovering oil from a reservoir utilizing the oil recovery medium, an arrangement for recovering oil from a reservoir, and a method of using an oil recovery medium or an arrangement for recovering oil from a reservoir.

### BACKGROUND

The recovery of oil from the ground, such as an oil field, often suffers from an insufficient yield of recovery of the crude oil. In particular with regard to heavy oil, which typically amounts to approximately 80% of an oil field, the recovery yield is typically only about 20 to 25%, depending on the physical parameters of the oil and of the field.

In order to increase the recovery yield, so-called tertiary recovery techniques or enhanced oil recovery (EOR) techniques have been developed and employed. Common tertiary recovery techniques include steam flooding, polymer flooding or surfactant flooding. However, any of these conventional tertiary recovery techniques suffers from technical, environmental and/or economic disadvantages.

In steam flooding, steam is pumped into a well or ground hole thereby introducing heat to the reservoir so as to reduce the viscosity of the crude oil. However by doing so, a very high consumption of energy is involved and a specific completion of the wells is required. Conventional drilling wells are not suitable for steam injection. In addition, most of the conventional transporting means, such as progressive cavity pumps, are not suitable because of an insufficient resistance to the existing high temperature of the materials, such as elastomers, employed therein. Even the suitability of submersible centrifugal pumps or centrifugal immersion pumps employing specific elastomers is limited and in addition very expensive. Moreover, acidic components, such as hydrogen sulphide, are released in steam flooding, which are harmful for both materials and environment.

In polymer flooding, polymeric compounds are added to the water to be injected into a well or ground hole. Thereby, the viscosity of the flooding liquid can be increased resulting in an improved replacement effect for the crude oil. However, these polymers show only little resistance to thermal and/or bacterial degradation so that their effect cannot be maintained for a long time.

Surfactant flooding techniques are disadvantageous for both environmental and economic reasons.

In view of the ever increasing demand for exploiting the limited resources of oil with higher yields, an enhanced oil recovery technique is needed that is beneficial in any one of technical, environmental and economic perspectives.

In light of the foregoing, embodiments of the invention aim at overcoming the above described problems and drawbacks of hitherto available tertiary oil recovery techniques. In particular, there may be a need to provide a medium suitable for enhanced oil recovery which can efficiently replace or push oil out of a reservoir, is environmentally uncritical, and is resistant to thermal and bacterial degradation.

### SUMMARY OF THE INVENTION

The present inventor has found that by the addition of potassium carbonate to the flooding liquid, the chemical and physical properties of the flooding liquid can be manipulated in such a manner that an optimized replacement fluid for oil from the ground can be obtained enabling an improved recovery rate of the oil.

Accordingly, an exemplary embodiment of the invention relates to an oil recovery medium for injection into a ground hole, such as a well or a borehole, in a ground which comprises (crude or raw) oil, wherein the oil recovery medium comprises a base liquid and potassium carbonate.

The oil recovery medium according to embodiments of the invention is in particular suitable for recovering oil from a reservoir by replacement.

Accordingly, another exemplary embodiment of the invention relates to a method of recovering oil from a reservoir (such as an oil reservoir), wherein the method comprises injecting an oil recovery medium having the above mentioned features into at least a part of the oil reservoir whereby the oil recovery medium replaces oil from the oil reservoir (in particular, oil is pushed out of the reservoir by the oil recovery medium).

Another exemplary embodiment of the invention relates to an arrangement for recovering oil from a reservoir, wherein the arrangement comprises a borehole configured for forming access from the surface (such as from the earth's surface) to the reservoir, and an oil recovery medium having the above mentioned features for injection and displacement at least a part of the oil.

In addition, another exemplary embodiment of the invention relates to a method of using (or simply the use of) an oil recovery medium having the above mentioned features or an arrangement having the above mentioned features for recovering oil from a reservoir, in particular by replacement.

### DETAILED DESCRIPTION OF THE INVENTION

Hereinafter, details of embodiments of the invention and other features and advantages thereof will be described. However, the invention is not limited to the following specific descriptions, but they are rather for illustrative purposes only.

It should be noted that features described in connection with one exemplary embodiment or exemplary aspect may be combined with any other exemplary embodiment or exemplary aspect, in particular features described with any exemplary embodiment of the oil recovery medium may be combined with any exemplary embodiment of a method of recovering oil, an arrangement for recovering oil from a reservoir or a method of using an oil recovery medium or an arrangement for recovering oil from a reservoir and vice versa, unless specifically stated otherwise.

Where an indefinite or definite article is used when referring to a singular term, such as “a”, “an” or “the”, a plural of that term is also included and vice versa, unless specifically stated otherwise.

The expression “comprising”, as used herein, includes not only the meaning of “comprising”, “including” or “containing”, but also encompasses “consisting essentially of” and “consisting of”.

Unless specifically stated otherwise, the expressions “at least partially”, “at least part of” or “at least a part of”, as used herein, may mean at least 5% thereof, in particular at least 10% thereof, in particular at least 15% thereof, in particular at least 20% thereof, in particular at least 25% thereof, in particular at least 30% thereof, in particular at least 35% thereof, in particular at least 40% thereof, in particular at least 45% thereof, in particular at least 50% thereof, in particular at least 55% thereof, in particular at least 60% thereof, in particular at least 65% thereof, in particular at least 70% thereof, in particular at least 75% thereof, in particular at least 80% thereof, in particular at least 85% thereof, in particular at least 90% thereof, in particular at least 95% thereof, in particular at least 98% thereof, and may also mean 100% thereof.

In a first aspect, an exemplary embodiment of the invention relates to an oil recovery medium for injection into a ground hole in a ground comprising oil, wherein the oil recovery medium comprises a base liquid and potassium carbonate. In particular, the oil recovery medium is for injection into a reservoir, such as an oil reservoir.

The term “oil recovery medium”, as used herein, may in particular denote a replacement fluid for oil which may be used for pushing out oil from the ground. In particular, the oil recovery medium may be pumped or injected into a deep borehole for replacing (or supplanting) oil present in the ground from its deposit. Thereby, the replaced oil can be driven (or pushed) out of the reservoir and eventually out of the ground to the earth's surface. The oil recovery medium may in particular be a flooding fluid. The oil recovery medium may in particular be a solution, such as a clear solution. In particular, the oil recovery medium may form a single phase, i.e. it does not represent a dispersion, such as a suspension or an emulsion. In particular, the oil recovery medium may be free from solid particles, such as proppant particles typically used in a hydraulic fracturing medium. Thus, the oil recovery medium according to embodiments of the invention has to be distinguished from an oil (or gas) recovery medium used in hydraulic fracturing (fracking).

The term “ground hole”, as used herein, may in particular represent a borehole or a well. It may in particular denote a vertical, horizontal or slanted hole drilled in a formation, such as a rock, to access deeper regions of the formation in which oil may be located.

The term “reservoir”, as used herein, may in particular denote a subsurface pool of hydrocarbons, such as oil, contained in porous rock formations.

The term “base liquid”, as used herein, may in particular denote a liquid component of the oil recovery medium to which solid components, such as potassium carbonate, may be added to render them flowable and in particular to (completely) dissolve them.

The term “oil”, as used herein, may in particular denote raw oil or crude oil, i.e. oil in a form how it can be found in nature.

The base liquid may in particular comprise or consist of water. Thus, pure water being available in large amounts and being completely biocompatible can be used for the oil recovery medium. However, alternatively other basic liquids may be implemented such as biocompatible organic solvents.

In an embodiment, the water is selected from the group consisting of fresh, brackish or even sea water or salt water, and deposit or saline water from aquifers. Fresh water, for instance tap water, is cheap and available even in large quantities. Deposit water or separated water from oil production (reservoir fluid), for instance directly from the ground hole formed for recovery of the oil, is available directly at the location where the oil recovery medium is employed. Hence, the use of deposit or separated water from oil production (reservoir fluid) is highly efficiently and does not deteriorate the properties of the oil recovery medium.

The oil recovery medium comprises potassium carbonate (K₂CO₃). Depending on its origin, the potassium carbonate may contain impurities of other salts or ions as well. Likewise, it may contain water of crystallization, such as potassium carbonate monohydrate, potassium carbonate sesquihydrate or potassium carbonate dihydrate. The potassium carbonate may also be anhydrous. Potassium carbonate can be found in nature and can also be prepared synthetically, for instance by absorbing carbon dioxide in potassium hydroxide. Potassium carbonate has turned out as an ideal component for an oil recovery medium to meet the need discussed above.

Potassium carbonate is highly soluble in water (approximately 1120 g/l at 20° C.) so that it may serve as an appropriate means for increasing the density of the oil recovery medium thereby improving its ability to replace oil from the reservoir and to exert a buoyancy effect on the replaced oil. Likewise, the viscosity of the oil recovery medium may be controlled by potassium carbonate; thereby it may allow a further improvement in the ability of the oil recovery medium to replace oil from the reservoir. Moreover, the pH value of the oil recovery medium may be controlled by potassium carbonate; thereby it may buffer and consequently remove acidic components, such as carbon dioxide or hydrogen sulphide.

In addition, potassium carbonate has corrosion inhibiting properties and thereby it may prevent metallic parts of equipment in contact with the oil recovery medium from corroding. In view of its presence in nature, potassium carbonate is biocompatible and environmentally uncritical. Moreover, potassium carbonate is resistant to thermal degradation (up to about 900° C.) as well as to bacterial degradation.

A particular beneficial property of potassium carbonate, in particular of the potassium ions thereof, is the ability of stabilizing clay mineral. In particular, it may prevent swelling of clay minerals contained in the ground adjacent to the ground hole. Thereby, it may serve to maintain the ground hole in a form suitable for allowing transport of replaced oil from the ground; in other words, the potassium carbonate helps to avoid the formation of obstructions or blockages in the ground hole by swelling of the surrounding ground.

Thus, potassium carbonate has been shown to be of particular advantage for use in an oil recovery medium (as well as in the other aspects of embodiments of the invention) so as to meet the need discussed above.

In an embodiment, a ratio between a mass of the potassium carbonate and a volume of the base liquid is in the range of from 1000 g/l to 1100 g/l, in particular in the range of from 1010 g/l to 1090 g/l. Hereby, the above mentioned advantageous effects of potassium carbonate may be particularly pronounced.

In an embodiment, the base liquid and the potassium carbonate are biocompatible materials, in particular natural materials. Thus, any detrimental impact of the oil recovery medium to the environment may be avoided.

In an embodiment, the oil recovery medium is resistant to thermal and/or bacterial degradation. Thus, the oil recovery medium may show a high stability and the advantageous effects thereof may be maintained over a long period of time.

In an embodiment, the oil recovery medium reduces, in particular prevents, swelling of clay minerals contained in the ground. Thus, it may serve to maintain the ground hole in a form suitable for allowing transport of replaced oil from the reservoir.

In an embodiment, the oil recovery medium consists of the base liquid and potassium carbonate. In other words, in such embodiment no other components are contained in the oil recovery medium except for the base liquid, potassium carbonate and uncritical impurities. Thereby, a very cost-efficient and environment-friendly oil recovery medium can be provided.

In an embodiment, the oil recovery medium is a non-fracturing oil recovery medium. In particular, the oil recovery medium may be configured so as to not (mechanically, physically and/or chemically) manipulate the ground surrounding the ground holes, such as by forming fractures or additional channels.

In a second aspect, an exemplary embodiment of the invention relates to a method of recovering oil from a reservoir, in particular an oil reservoir, wherein the method comprises injecting an oil recovery medium having the above mentioned features into at least a part of the oil reservoir whereby the oil recovery medium replaces oil from the oil reservoir.

Prior to the injection of the oil recovery medium, the method may further comprise the formation of a borehole (well) in the ground so as to enable access from the (earth's) surface to the reservoir. The borehole may be formed in the ground by any conventional method in the field of oil recovery, such as (well) drilling or boring.

The oil recovery medium may be injected into at least a part of the oil reservoir by any conventional measure in a passive way and/or in an active way, such as by pumping. It might be advantageous to inject or introduce the oil recovery medium under pressure (elevated pressure), such as by using a (high-pressure) pump. Thereby, the replacement of oil from the reservoir by the oil recovery medium may be improved.

When injected into at least a part of the reservoir, the oil recovery medium replaces (supplants, displaces) oil present in the reservoir from the ground. However, the ground will preferably not be (mechanically, physically and/or chemically) manipulated, such as fractured, by the oil recovery medium or in the method of recovering oil. Thus, the method may in particular be a non-fracturing method of recovering oil from a reservoir.

By injecting the oil recovery medium into at least a part of the reservoir and replacement of the oil from the reservoir, the oil may be driven (pushed) out of the reservoir (e.g. via the borehole) to the (earth's) surface. In particular, the oil may be flooded to the surface.

The oil may be in particular heavy oil and/or raw oil, in particular heavy raw oil. Such oil is typically highly viscous and is therefore difficult to recover. However, by the method according to embodiments of the invention, in particular by using the oil recovery medium of embodiments of the invention, such oil can be very effectively recovered with an increased recovery yield and in a beneficial manner from any one of a technical, environmental and economic view. Thus, the method according an exemplary embodiment of the invention is in particular suitable for the recovery of such oil, but may of course be used for the recovery of other types of oil as well.

In a third aspect, an exemplary embodiment of the invention relates to an arrangement for recovering oil from a reservoir, wherein the arrangement comprises a borehole configured for forming (enabling) access from the surface to the reservoir, and an oil recovery medium having the above mentioned features for injection into at least a part of the borehole and/or the reservoir and for displacement of the oil.

The borehole may be formed by any conventional equipment in the field of oil recovery suitable for forming a borehole in a ground, such as bore or drill equipment. The arrangement may further comprise such equipment.

The borehole may comprise one or more vertical borehole sections and/or one or more horizontal borehole sections, wherein different sections may be interconnected to one another and wherein slanted borehole sections are possible as well.

In a fourth aspect, an exemplary embodiment of the invention relates to a method of using (or to the use of) an oil recovery medium having the above mentioned features or an arrangement having the above mentioned features for recovering oil from a reservoir. In particular, the oil may be recovered from the reservoir by replacement by the oil recovery medium, as explained in further detail in the foregoing. The oil may be in particular heavy oil and/or raw oil, in particular heavy raw oil, as explained in further detail in the foregoing.

While embodiments of the invention have been described in detail by way of specific embodiments and examples, the invention is not limited thereto and various alterations and modifications are possible, without departing from the scope of the invention.

1. An oil recovery medium for injection into a ground hole in a ground comprising oil, wherein the oil recovery medium comprises:
a base liquid; and
potassium carbonate.

2. The oil recovery medium according to claim 1, wherein the oil recovery medium consists of a base liquid and potassium carbonate.

3. The oil recovery medium according to claim 1, wherein the oil recovery medium is a solution.

4. The oil recovery medium according to claim 1, wherein the base liquid comprises or consists of water.

5. The oil recovery medium according to claim 4, wherein the water is selected from the group consisting of fresh water, brackish or salt water, and deposit or separated water from oil production.

6. The oil recovery medium according to claim 1, wherein a ratio between a mass of the potassium carbonate and a volume of the base liquid is in the range of from 1000 g/l to 1100 g/l.

7. The oil recovery medium according to claim 1, wherein the base liquid and the potassium carbonate are biocompatible materials, in particular natural or artificial materials.

8. The oil recovery medium according to claim 1, wherein the oil recovery medium is resistant to thermal and/or bacterial degradation.

9. The oil recovery medium according to claim 1, wherein the oil recovery medium reduces, in particular prevents, swelling of clay minerals contained in the ground.

10. The oil recovery medium according to claim 1, wherein the oil recovery medium is a non-fracturing oil recovery medium.

11. A method of recovering oil from a reservoir, wherein the method comprises:
injecting an oil recovery medium according to claim 1 into at least a part of the oil reservoir whereby the oil recovery medium replaces oil from the oil reservoir.

12. The method according to claim 11, wherein the method is a non-fracturing method of recovering oil from a reservoir.

13. An arrangement for recovering oil from a reservoir, wherein the arrangement comprises:
a borehole configured for forming access from the surface to the reservoir; and
an oil recovery medium according to claim 1 for injection and displacement at least a part of the oil.

14. A method of using an oil recovery medium according to claim 1 for recovering oil from a reservoir.

15. A method of using an arrangement according to claim 13 for recovering oil from a reservoir.
